(19) United States
(12) Patent Application Publication
(10) Pub. No.: US 2025/0319885 A1
(43) Pub. Date: Oct. 16, 2025

(54) VEHICLE CONTROL APPARATUS, VEHICLE CONTROL METHOD, AND SYSTEM FOR PROVIDING VEHICLE CONTROL SERVICE

(71) Applicants: Hyundai Motor Company, Seoul (KR); Kia Corporation, Seoul (KR)

(72) Inventor: Young Seok Jo, Hwaseong-Si (KR)

(21) Appl. No.: 18/953,741

(22) Filed: Nov. 20, 2024

(30) Foreign Application Priority Data
Apr. 16, 2024 (KR) 10-2024-0050900

(51) Int. Cl. B60W 50/00; B60W 50/14

(52) U.S. Cl. CPC B60W 50/0098; B60W 50/14; B60W 2050/146

(57) ABSTRACT

A vehicle control apparatus may include a memory storing at least one instruction and a processor that executes the at least one instruction. The processor may obtain, from a server and among a plurality of settings for controlling an interior environment of a vehicle, a setting specified by an input of a user of the vehicle. The plurality of settings include at least one of an image, a sound, or a lighting state. The processor may control, based on the setting, at least one of: a display of the vehicle to provide the image, a speaker of the vehicle to provide the sound, or a light source of the vehicle to provide lighting according to the lighting state.

### CROSS-REFERENCE TO RELATED APPLICATION

This application claims the benefit of priority to Korean Patent Application No. 10-2024-0050900, filed in the Korean Intellectual Property Office on Apr. 16, 2024, the entire contents of which are incorporated herein by reference.

### TECHNICAL FIELD

The present disclosure relates to a vehicle control apparatus, a vehicle control method, and a system for providing a vehicle control service, and more particularly, relates to technologies for controlling an interior environment of a vehicle.

### BACKGROUND

As the society becomes more complex and the mobility (e.g., transportation) technology advances, there is a renewed interest in reclaiming the interior space of a vehicle as a personal space.

As the concept of a user experience is now considered to encompass not only the convenience and stability of driving of the vehicle, but also the convenience and comfort in the personal space, the importance of building a personalized and user-friendly interior (e.g., internal) space is gaining attention.

Furthermore, the consumer demand for a vehicle with a personalized entertainment function and a personized and customized services is expected to continue to rise.

### SUMMARY

The present disclosure has been made to solve the above-mentioned problems occurring in at least some implementations while advantages achieved by those implementations are maintained intact.

An aspect of the present disclosure provides a vehicle control apparatus for providing a setting for controlling an interior environment of a vehicle, a vehicle control method, and a system for providing a vehicle control service.

Another aspect of the present disclosure provides a vehicle control apparatus for providing a setting including a combination of elements constituting an interior environment of a vehicle, a vehicle control method, and a system for providing a vehicle control service.

Another aspect of the present disclosure provides a vehicle control apparatus for sharing a setting for controlling an interior environment of a vehicle, a vehicle control method, and a system for providing a vehicle control service.

Another aspect of the present disclosure provides a vehicle control apparatus for ensuring a vehicle space as a personal space and providing a mood according to activity of a user, a vehicle control method, and a system for providing a vehicle control service.

Another aspect of the present disclosure provides a vehicle control apparatus for customizing a setting for controlling an interior environment of a vehicle, a vehicle control method, and a system for providing a vehicle control service.

Another aspect of the present disclosure provides a vehicle control apparatus for controlling an interior environment of a vehicle by means of a setting for controlling the interior environment of the vehicle to provide an expanded user experience, a vehicle control method, and a system for providing a vehicle control service.

Another aspect of the present disclosure provides a vehicle control apparatus for allowing a platform to ensure profits by means of transaction brokerage of a setting for controlling an interior environment of a vehicle, a vehicle control method, and a system for providing a vehicle control service.

Another aspect of the present disclosure provides a vehicle control apparatus for allowing a platform to ensure big data by means of transaction brokerage of a setting for controlling an interior environment of a vehicle, a vehicle control method, and a system for providing a vehicle control service.

Another aspect of the present disclosure provides a vehicle control apparatus for ensuring a communication ecosystem between vehicles by means of transaction brokerage of a setting for controlling an interior environment of a vehicle, a vehicle control method, and a system for providing a vehicle control service.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a memory storing at least one instruction; and a processor configured to execute the at least one instruction to obtain, from a server and among a plurality of settings for controlling an interior environment of a vehicle, a setting specified by an input of a user of the vehicle. The plurality of settings may include at least one of an image, a sound, or a lighting state. The processor may be further configured to execute the at least one instruction to control, based on the setting, at least one of: a display of the vehicle to provide the image, a speaker of the vehicle to provide the sound, or a light source of the vehicle to provide lighting according to the lighting state.

The input of the user indicates at least one of: an autonomous driving level of the vehicle, or an autonomous driving operation of the vehicle.

The setting may further include at least one of: a seat position of a seat of the vehicle, an interior temperature of the vehicle, or a window position of a window of the vehicle. The processor may be further configured to execute the at least one instruction to control, based on the setting, at least one of: the seat according to the seat position, an air conditioner of the vehicle according to the interior temperature of the vehicle, or the window according to the window position.

The setting may be recommended based on at least one user category of the user. The processor may be configured to obtain the setting by: obtaining the setting from the server via a communication device, of the vehicle, configured to perform wireless or wired communication.

The processor may be further configured to execute the at least one instruction to: obtain, via a user interface and among a second plurality of settings for controlling the interior environment, a second setting. The second plurality of settings may be stored in the vehicle control apparatus. The processor may be further configured to execute the at least one instruction to control, based on the second setting, at least one of the display, the speaker, or the light source; and provide the user with information about the second setting.

The processor may be further configured to execute the at least one instruction to obtain, among a second plurality of settings for controlling the interior environment, a second setting corresponding to driving information associated with the vehicle. The second plurality of settings may be stored in the vehicle control apparatus. The processor may be further configured to execute the at least one instruction to control, based on the second setting, at least one of the display, the speaker, or the light source.

At least one of the image, the sound, or the lighting state may be associated with a media content.

The processor may be further configured to execute the at least one instruction to: obtain, among a second plurality of settings for controlling the interior environment, a second setting corresponding to context information indicating an activity performed by the user; and control, based on the second setting, at least one of the display, the speaker, or the light source.

According to one or more example embodiments of the present disclosure, a system for providing a vehicle control service may include: a vehicle control apparatus; and a terminal of a user of a vehicle. The terminal is configured to: transmit, to a server, a request to send, to the vehicle control apparatus and among a plurality of settings for controlling an interior environment of the vehicle, a setting specified by an input of the user. The plurality of settings may include at least one of an image, a sound, or a lighting state. The vehicle control apparatus may be configured to: receive, from the server; and control, based on the setting, at least one of: a display of the vehicle to provide the image, a speaker of the vehicle to provide the sound, or a light source of the vehicle to provide lighting according to the lighting state.

The terminal may be further configured to: present, to the user via an application executing on the terminal, the plurality of settings.

The terminal may be further configured to: transmit a request for an authorization for a transaction associated with the setting.

At least one of the vehicle control apparatus or the server may be further configured to: classify, based on personal information of the user, the user into at least one category; and generate, for the user and based on a preference of other users in the at least one category, at least one recommended setting for controlling the interior environment. The terminal may be further configured to: provide, to the user, the at least one recommended setting.

The terminal may be further configured to receive, from a second terminal associated with a second user, first information about at least one setting customized by the second user. The setting specified by the input of the user may be based on the first information. The terminal may be further configured to transmit, to the second terminal, second information about at least one setting customized by the user to control the interior environment; and transmit, to the server, the at least one setting customized by the user to control the interior environment.

According to one or more example embodiments of the present disclosure, a vehicle control method may include obtaining, by a processor, from a server, and among a plurality of settings for controlling an interior environment of a vehicle, a setting specified by an input of a user of the vehicle. The plurality of settings may include at least one of an image, a sound, or a lighting state. The vehicle control method may further include controlling, by the processor and based on the setting, at least one of: a display of the vehicle to provide the image, a speaker of the vehicle to provide the sound, or a light source of the vehicle to provide lighting according to the lighting state.

The setting may further include at least one of: a seat position of a seat of the vehicle, an interior temperature of the vehicle, or a window position of a window of the vehicle. The vehicle control method may further include controlling, by the processor and based on the setting, at least one of: the seat according to the seat position, an air conditioner of the vehicle according to the interior temperature of the vehicle, or the window according to the window position.

The setting may be recommended based on at least one user category of the user. Obtaining the setting may include obtaining the setting from the server via a communication device, of the vehicle, configured to perform wireless or wired communication.

The vehicle control method may further include obtaining, by the processor, via a user interface, and among a second plurality of settings for controlling the interior environment, a second setting. The second plurality of settings may be stored in a vehicle control apparatus. The vehicle control method may further include controlling, by the processor and based on the second setting, at least one of the display, the speaker, or the light source; and providing, by the processor, the user with information about the second setting.

The vehicle control method may further include obtaining, by the processor and among a second plurality of settings for controlling the interior environment, a second setting corresponding to driving information associated with the vehicle.

The second plurality of settings may be stored in a vehicle control apparatus. The vehicle control method may further include: controlling, by the processor and based on the second setting, at least one of the display, the speaker, or the light source.

At least one of the image, the sound, or the lighting state may be associated with a media content.

The vehicle control method may further include: obtaining, by the processor and among a second plurality of settings for controlling the interior environment, a second setting corresponding to context information indicating an activity performed by the user; and controlling, by the processor and based on the second setting, at least one of the display, the speaker, or the lighting, or the light source.

The settings may further include: one or more settings shared by a second user and customized by the second user.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a system for providing a vehicle control service;

FIG. 2 is a block diagram illustrating a configuration of a vehicle control apparatus;

FIG. 3 illustrates an example of an internal environment of a vehicle, in a vehicle control apparatus, a vehicle control method, and a system for providing a vehicle control service;

FIG. 4 illustrates an example of signaling among a server of a platform, a terminal of a user, and a vehicle control apparatus, in the vehicle control apparatus, a vehicle control method, and a system for providing a vehicle control service;

FIG. 5 is flow of an operation of a vehicle control apparatus, in the vehicle control apparatus, a vehicle control method, and a system for providing a vehicle control service; and

FIG. 6 illustrates a computing system associated with a vehicle control apparatus, a vehicle control method, and a system for providing a vehicle control service.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Furthermore, in the present disclosure, the expression “greater than” or “less than” is used to determine whether a specific condition is satisfied or fulfilled, but is only to represent an example and does not exclude the description “greater than or equal to” or “less than or equal to”. A condition described as being “greater than or equal to” may be replaced with a condition described as being “greater than”, a condition describing as being “less than or equal to” may be replaced with a condition described as being “less than”, and a condition described as being “greater than or equal to and less than” may be replaced with “greater than and less than or equal to”. Furthermore, hereinafter, the expression “A to B” refers to at least one of elements (including B) from A to B (including A).

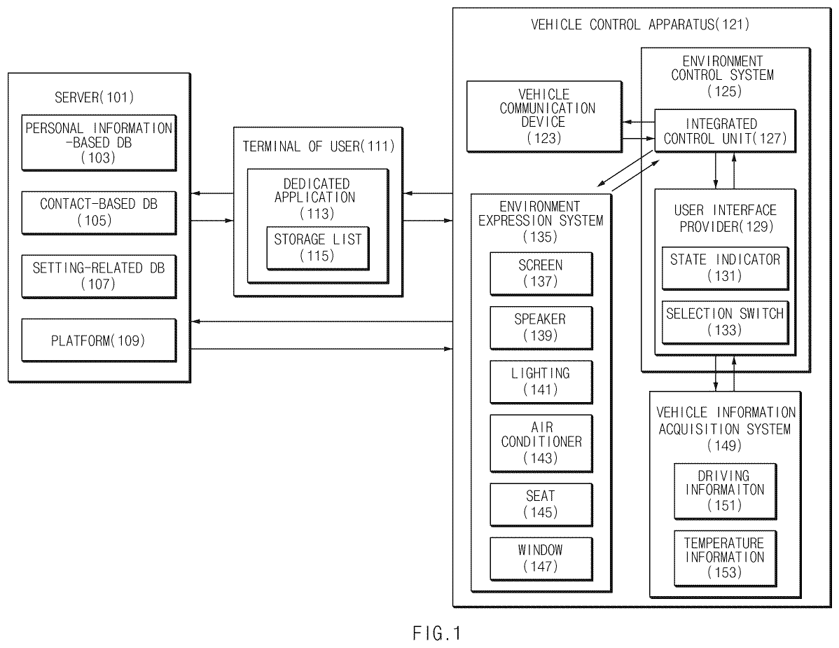

Hereinafter, embodiments of the present disclosure will be described in detail with reference to FIGS. 1 to 6.

FIG. 1 is a block diagram illustrating a configuration of a system for providing a vehicle control service.

Referring to FIG. 1, the system for providing the vehicle control service may include a server 101, a terminal 111 of a user, and a vehicle control apparatus 121. The server 101 may provide a personal information-based database (DB) 103, a contact-based DB 105, a setting-related DB 107, and a platform 109. The server 101 may include a server of the platform 109.

The terminal 111 of the user may include a dedicated application 113 which provides a storage list 115.

The vehicle control apparatus 121 may include a vehicle communication device 123, an environment control system 125, an environment expression system 135, and a vehicle information acquisition system 149. The environment control system 125 may include an integrated control unit 127 and a user interface provider 129. The user interface provider 129 may include a state indicator 131 and a selection switch 133. The environment expression system 135 may include a screen 137, a speaker 139, a light source 141, an air conditioner 143, a seat 145, and a window 147. The vehicle information acquisition system 149 may include driving information 151 and temperature information 153. The driving information 151 may include at least one of speed information of a vehicle, position information of the vehicle, destination information of the vehicle, or starting point information of the vehicle, or any combination thereof. The temperature information 153 may include at least one of internal (e.g., interior) temperature information of the vehicle or external temperature information of the vehicle, or any combination thereof.

The vehicle control apparatus 121 may control an internal environment (e.g., an interior environment) of the vehicle depending on a vehicle usage state.

For example, the vehicle usage state may include driving information (e.g., destination information, starting point information, or speed information) of the vehicle, state information of the vehicle (e.g., door opening and closing information for allowing a new passenger to ride), information about activity of the user, which is performed in the vehicle, (e.g., information about a type of a task such as a meeting, paperwork, or relaxation), user personal information (e.g., information about media content viewed by the user, birthday information, or family event information), or environmental information (e.g., weather information, day information, or date information). In addition, the vehicle control apparatus 121 may include various pieces of information.

For example, the interior environment of the vehicle may be controlled by controlling at least one of the screen 137 provided in the vehicle to provide an image, the speaker 139 provided in the vehicle to provide a sound, the light source 141 provided in the vehicle to lighting according to a lighting state, the at least one seat 145 provided and arranged in the vehicle, the air conditioner 143 provided in the vehicle to adjust an interior temperature, or the window 147 provided in the vehicle such that its opening and closing degree is adjusted, or any combination thereof. The user may store, manage, and share a setting for controlling an interior environment, which is a stored setting combination. The screen 137 may be included in a display.

The setting for controlling the interior environment of the vehicle may be configured based on a specific theme.

For example, if the user performs a task requiring concentration in the vehicle, the vehicle control apparatus 121 may provide an image including grand spaces, ancient books, and classic patterns by means of the screen 137, may provide library white noise by means of the speaker 139, and may provide an off-white lighting state with variable intensity by means of the light source 141. The setting for controlling the interior environment of the vehicle may be configured based on such a specific theme.

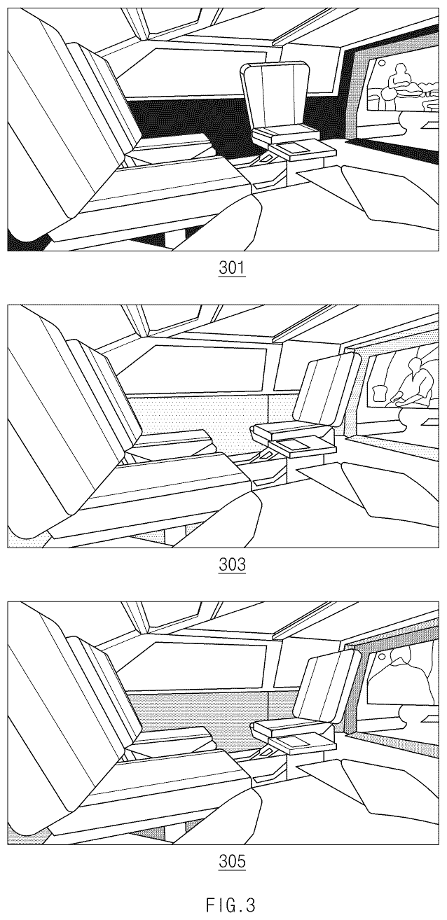

Detailed examples for the setting for controlling the interior environment, which is configured based on the specific theme, will be described below with reference to FIG. 3.

The terminal 111 of the user may provide the user with information about settings obtained from the server 101, based on the execution of the dedicated application 113 for providing the user with the settings for controlling the interior environment, which include at least one of the image, the sound, the lighting state, the arrangement of the seat, the interior temperature of the vehicle, or the window opening and closing degree, or any combination thereof.

If the dedicated application 113 is installed in the terminal 111 of the user, the terminal 111 of the user may request the server 101 such that the environment control system 125 of the vehicle control apparatus 121 obtains a specified setting by means of the dedicated application 113.

The dedicated application 113 may obtain personal information (e.g., a photo of the user, contact information of the user, an age group of the user, a job of the user, or a preference of the user) by means of a BlueLink linkage method. The user may execute the dedicated application 113 to control the environment control system 125 by means of the BlueLink linkage method. However, an embodiment of the present disclosure may not be limited thereto.

According to an embodiment, the server 101 may classify the user into at least one category (e.g., a category according to the age group, a category according to the job, and a category according to the preference) based on the personal information of the user. The server 101 may recommend at least one setting for controlling an interior environment to the user, based on a frequency at which users included in the at least one category and different from the user (e.g., users included in the age group category of the user, users included in the job category of the user, and users included in the preference category of the user) obtain a setting for controlling an interior environment of another vehicle. In other words, the recommendation may be based on a preference of other users in the same category.

According to an embodiment, the terminal 111 of the user may provide the user with the recommended setting by means of the dedicated application 113.

According to an embodiment, the terminal 111 of the user may provide the user with the storage list 115 including pieces of content stored in the vehicle control apparatus 121 or the terminal 111 of the user, based on the execution of the dedicated application 113.

According to an embodiment, the terminal 111 of the user may transmit a request for allowing the vehicle control apparatus 121 to obtain a setting specified based on an input of the user among settings for controlling an interior environment corresponding to the information provided to the user to the server 101. The input of the user may indicate, for example, an autonomous driving level of the vehicle and/or an autonomous driving operation of the vehicle.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

According to an embodiment, the vehicle control apparatus 121 may obtain a setting specified based on the input of the user among settings for controlling an interior environment, which are recommended based on the at least one category into which the user is classified, from the server 101 via the vehicle communication device 123 provided in the vehicle to perform wireless or wired communication. The vehicle communication device 123 may be, for example, a communication device, such as a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.

According to an embodiment, the server 101 may transmit the specified setting to the vehicle control apparatus 121, in response to receiving the request. However, an embodiment of the present disclosure may not be limited thereto. According to an embodiment, the server 101 may transmit the specified setting to the terminal 111 of the user rather than the vehicle control apparatus 121. If the server 101 transmits the specified setting to the terminal 111 of the user, the terminal 111 of the user may transmit the setting obtained from the server 101 to the vehicle control apparatus 121.

According to an embodiment, the vehicle control apparatus 121 may obtain the specified setting, via the vehicle communication device 123 provided in the vehicle to perform wireless or wired communication. The vehicle control apparatus 121 may control at least one of the display provided in the vehicle to provide an image, the speaker 139 provided in the vehicle to provide a sound, or the light source 141 provided in the vehicle to provide lighting according to a lighting state, or any combination thereof, based on the obtained setting.

According to an embodiment, if the specified setting is paid content, then the server 101 may transmit the specified setting to the vehicle control apparatus 121 only if the terminal 111 makes a payment of a fee (e.g., price) associated with the specified setting. In other words, the terminal 111 of the user may pay the fee for the specified setting and may then transmit, to the server 101, a request for authorization of a transaction associated with the setting (e.g., a request for allowing the vehicle control apparatus 121 to obtain the specified setting). The server 101 may transfer an amount corresponding to a portion or all of the fee to an account of a seller who uploaded the specified setting to the server 101. However, an embodiment of the present disclosure may not be limited thereto.

According to an embodiment, an operator of the platform 109 may obtain profits in the process of brokering and managing a transaction between the seller and the user. For example, the server 101 may perform at least one of charging the user a fee, charging the seller the fee, or obtaining cost for an advertisement posted on the platform 109 from an advertiser, or any combination thereof, in the process of brokering and managing the transaction between the seller and the user. However, an embodiment of the present disclosure may not be limited thereto.

According to an embodiment, the terminal 111 of the user may obtain settings for controlling the interior environment of the vehicle by means of the platform 109.

For example, if the specified setting is paid and only if the terminal 111 of the user pays the price of the specified setting by means of the platform 109, the server 101 may transmit the specified setting to the vehicle control apparatus 121. In other words, the terminal 111 of the user may pay the price of the specified setting by means of the platform 109 and may then transmit the request to the server 101 by means of the platform 109. The server 101 may transfer the amount corresponding to the portion or all of the price to the account of the seller who uploads the specified setting to the server 101 by means of the platform 109. However, an embodiment of the present disclosure may not be limited thereto.

According to an embodiment, the terminal 111 of the user may share and receive at least one setting, which is customized by a user different from the user (e.g., an influencer or an acquaintance of the user) to control the interior environment, by means of the platform 109. In other words, the terminal 111 of the user may receive information about the at least one setting, which is customized by the user different from the user to control the interior environment, from the different user by means of the platform 109. The terminal 111 of the user may transmit the request for allowing the vehicle control apparatus 121 to obtain the setting specified by the input of the user to the server 101, based on the received information, by means of the platform 109.

Furthermore, the terminal 111 of the user may share the information about the at least one setting, which is customized by the user to control the interior environment, with the different user by means of the platform 109. The terminal 111 of the user may transmit the at least one setting, which corresponds to the shared information and is customized to control the information, to the server 101.

According to an embodiment, the terminal 111 of the user may provide the user with a setting list for each theme or a setting list according to labeling.

According to an embodiment, the server 101 may store the personal information obtained from the terminal 111 of the user in the personal information-based DB 103 and may store a contact obtained from the terminal 111 of the user in the contact-based DB 105. The server 101 may store settings for controlling the interior environment of the vehicle in the setting-related DB 107.

According to an embodiment, the server 101 may identify the user by means of the personal information stored in the personal information-based DB 103 and may generate an account of the user. The server 101 may register an image obtained from the terminal 111 of the user as a profile photo in the account of the user. The server 101 may provide a function of sharing or recommending content to another user, based on the contact obtained from the terminal 111 of the user, which is registered in the account of the user. The server 101 may provide a function of adding or recommending the other user as a friend, based on the obtained contact.

According to an embodiment, the environment control system 125 provided in the vehicle to include the integrated control unit 127 and the user interface provider 129 may automatically or semi-automatically control the interior environment of the vehicle. In other words, the environment control system 125 may determine a setting for controlling the interior environment based on at least one of the driving information 151 of the vehicle, the temperature information 153, or the context information of the user, or any combination thereof and may control the interior environment of the vehicle based on the determined setting. Alternatively, the environment control system 125 may control the interior environment of the vehicle depending on the setting for controlling the interior environment specified based on the input of the user.

According to an embodiment, the vehicle control apparatus 121 may display the information about the setting for controlling the interior environment, which is being provided by the vehicle control apparatus 121, by means of the state indicator 131 included in the user interface provider 129. According to an embodiment, the vehicle control apparatus 121 may obtain the setting specified based on the input of the user among the settings which are stored in the vehicle control apparatus 121 to control the interior environment selectable by the user, by means of the selection switch 133 included in the user interface provider 129. The selection switch 133 may include a user interface.

According to an embodiment, the integrated control unit 127 may obtain and store the setting for controlling the interior environment from the server 101. The integrated control unit 127 may control the interior environment of the vehicle by means of the environment expression system 135, based on a setting specified by means of the user interface provider 129 among the settings stored in the vehicle control apparatus 121 to control the interior environment. The integrated control unit 127 may obtain a setting corresponding to vehicle information (e.g., the driving information 151 or the temperature information 153) among the settings stored in the vehicle control apparatus 121 to control the interior environment, based on the vehicle information (e.g., the driving information 151 or the temperature information 153) obtained by means of the vehicle information acquisition system 149.

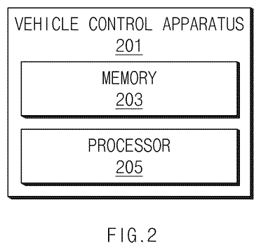

FIG. 2 is a block diagram illustrating a configuration of a vehicle control apparatus according to an embodiment of the present disclosure.

Referring to FIG. 2, a vehicle control apparatus 201 may include a memory 203 and a processor 205. The memory 203 may store at least on instruction for obtaining a setting for controlling an interior environment of a vehicle and controlling the interior environment of the vehicle based on the setting. The processor 205 may execute the at least one instruction stored in the memory 203. The at least one instruction may be referred to as at least one command.

According to an embodiment, the contents for the operation of the vehicle control apparatus 201 of FIG. 2 may be referred to the contents for the operation of the vehicle control apparatus 121 of FIG. 1. Therefore, hereinafter, duplicated contents thereof will be omitted.

FIG. 3 illustrates an example of an interior environment of a vehicle, in a vehicle control apparatus, a vehicle control method, and a system for providing a vehicle control service according to an embodiment of the present disclosure.

Referring to FIG. 3, a setting of a first interior environment 301 may correspond to context information if a user performs a task requiring concentration. A setting of a second interior environment 303 may correspond to context information if the user takes a rest. A setting of a third interior environment 305 may correspond to context information if the user performs meditation. The context information may indicate activity performed by the user.

According to an embodiment, a setting for controlling an interior environment of a vehicle may be configured based on a theme.

According to an embodiment, the setting of the first interior environment 301 may be configured based on a concentration theme in which the user performs a task requiring concentration in the vehicle.

According to an embodiment, if the user performs the task requiring the concentration in the vehicle, the vehicle control apparatus may provide the user with an image including grand spaces, ancient books, and classic patterns by means of a display, may provide the user with library white noise by means of a speaker, and may provide the user with an off-white lighting state with variable intensity by means of lighting. The sound may include an ambient sound such as white noise.

According to an embodiment, if the user talks on the phone with a friend who is not close to his or her family, handles personal business (e.g., real estate-related business), or studies his or her personal interests, the vehicle control apparatus may control an interior environment of the vehicle by means of the setting of the first interior environment 301. Furthermore, if a plurality of passengers view an image, the vehicle control apparatus may adjust the arrangement of the seat as the first interior environment 301 by means of the setting of the first interior environment 301. As such, the at least one seat may change in arrangement depending on the setting.

According to an embodiment, the setting of the second interior environment 303 may be configured based on a rest theme in which the user takes a rest in the vehicle.

According to an embodiment, if the user takes a rest in the vehicle, the vehicle control apparatus may provide the user with an image included in media content (e.g., all or a portion of a movie, all or a portion of a drama, or an image reminiscent of a movie background location) by means of the display, may provide the user with a sound included in the media content (e.g., movie music, movie dialogue, or an ambient sound reminiscent of a movie background location) by means of the speaker, and may provide the user with a lighting state of a color reminiscent of a neon sign by means of the light source.

According to an embodiment, the user may move the vehicle to a place in which he or she is able to rest, may view the media content, and may relax and think. According to an embodiment, if a theater is included in a starting point or a destination, the vehicle control apparatus may change the interior environment of the vehicle based on a setting corresponding to the media content, such that the user expands an experience for the media content.

According to an embodiment, the setting of the third interior environment 305 may be configured based on a rest theme in which the user takes a rest in the vehicle.

According to an embodiment, if the user performs the meditation in the vehicle, the vehicle control apparatus may provide the user with a smooth image (e.g., sand, wind, or a landscape) by means of the display, may provide the user with meditation music by means of the speaker, and may provide the user with lighting according to a lighting state of a warm color by means of the light source.

According to an embodiment, the user may determine an order of to-do lists in the vehicle, may relax, and may organize his or her thoughts.

According to an embodiment, the setting for controlling the interior environment of the vehicle may be configured based on various themes other than the themes associated with the interior environment shown in FIG. 3.

According to an embodiment, the vehicle control apparatus may control the interior environment based on a setting which is specified by a user who needs a change of mood and is configured according to a soothing theme.

According to an embodiment, the vehicle control apparatus may control the interior environment based on a setting which is specified by a user who eats in the vehicle and is configured according to a restaurant theme or a cafe theme.

According to an embodiment, the vehicle control apparatus may control the interior environment based on a corresponding media content theme determined by the context information of the user who watches the media content in the vehicle (e.g., a mysterious atmosphere of lighting and an interior temperature created according to a final scene of the media content).

According to an embodiment, the vehicle control apparatus may customize a setting including the image or the sound provided by the user. For example, the vehicle control apparatus may generate a memories theme by means of the image or the sound provided by the user. The vehicle control apparatus may transmit the customized theme to another vehicle control apparatus.

According to an embodiment, the vehicle control apparatus may obtain various themes, such as a theme reminiscent of a specific place, a memories theme, an office theme, a meeting theme, a task theme, an immersion/concentration theme, a meditation theme, a specific movie theme, a specific music theme, a weather theme, a year-end theme, a Christmas theme, and a party theme, and may provide the user with interior environments according to the various themes.

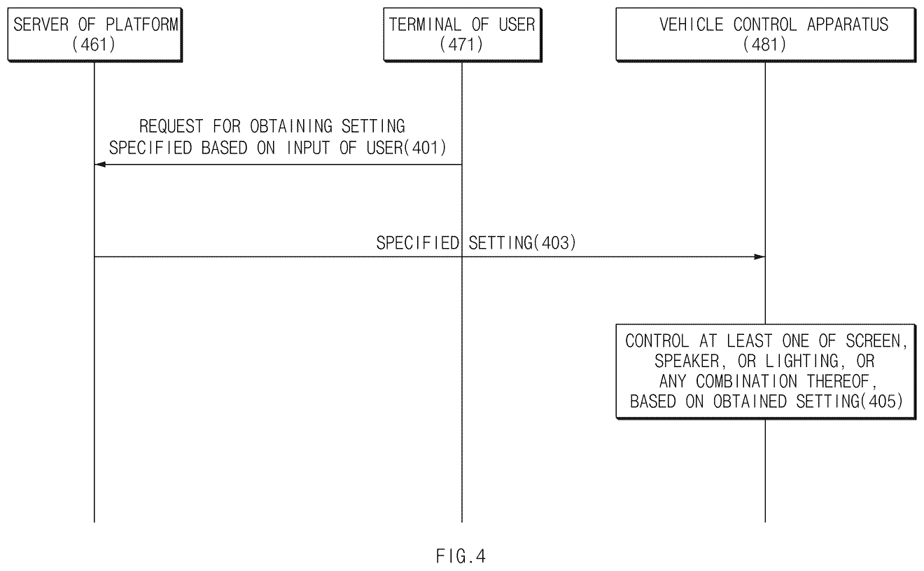

FIG. 4 illustrates an example of signaling among a server of a platform, a terminal of a user, and a vehicle control apparatus, in the vehicle control apparatus, a vehicle control method, and a system for providing a vehicle control service according to an embodiment of the present disclosure.

Hereinafter, it is assumed that a server 101, a terminal 111 of a user, and a vehicle control apparatus 121 of FIG. 1 or a vehicle control apparatus 201 of FIG. 2 performs a process of FIG. 4. Furthermore, in a description of FIG. 4, an operation described as being performed by a vehicle control apparatus may be understood as being controlled by a processor 205 of the vehicle control apparatus 201.

Referring to FIG. 4, in first operation 401, according to an embodiment, a terminal 471 of a user may transmit a request for obtaining a setting specified based on an input of the user to a server 461 of a platform. The server 461 of the platform may receive the request for obtaining the setting specified based on the input of the user from the terminal 471 of the user.

According to an embodiment, the request for obtaining the specified setting may include a request for allowing a vehicle control apparatus 481 to obtain a setting specified based on an input of the user among settings for controlling an interior environment of the vehicle, which include at least one of an image, a sound, or a lighting state, or any combination thereof.

In second operation 403, according to an embodiment, the server 461 of the platform may transmit the specified setting to the vehicle control apparatus 481. The vehicle control apparatus 481 may receive the specified setting from the server 461 of the platform.

In third operation 405, according to an embodiment, the vehicle control apparatus 481 may control at least one of a display, a speaker, a light source, or any combination thereof, based on the obtained setting.

According to an embodiment, the display may be provided in the vehicle to provide an image. The speaker may be provided in the vehicle to provide a sound. The light source may be provided in the vehicle to provide lighting according to a lighting state.

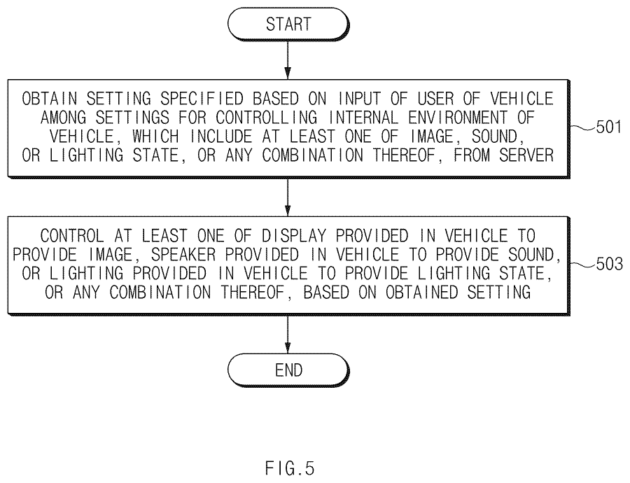

FIG. 5 is flow of an operation of a vehicle control apparatus, in the vehicle control apparatus, a vehicle control method, and a system for providing a vehicle control service according to an embodiment of the present disclosure.

Hereinafter, it is assumed that a vehicle control apparatus 121 of FIG. 1 performs a process of FIG. 5. Furthermore, in a description of FIG. 5, an operation described as being performed by a vehicle control apparatus may be understood as being controlled by a processor 205 of a vehicle control apparatus 201.

Referring to FIG. 5, in first operation 501, according to an embodiment, the vehicle control apparatus may obtain a setting specified based on an input of a user among settings for controlling an interior environment of a vehicle, which include at least one of an image, a sound, or a lighting state, or any combination thereof, from a server.

According to an embodiment, the settings for controlling the interior environment may further include at least one of arrangement of at least one seat provided in the vehicle, an interior environment of the vehicle, or an opening and closing degree of a window provided in the vehicle, or any combination thereof.

In second operation 503, according to an embodiment, the vehicle control apparatus 121 may control at least one of a display provided in the vehicle to provide an image, a speaker provided in the vehicle to provide a sound, or a light source provided in the vehicle to provide lighting according to a lighting state, or any combination thereof, based on the obtained setting.

According to an embodiment, the vehicle control apparatus may control at least one of at least one seat, an air conditioner provided in the vehicle, or a window, or any combination thereof, based on the obtained setting.

According to an embodiment, the user of the vehicle control apparatus may ensure a space where the user is free and undisturbed from the interference of others, a space where the user is able to fully enjoy the scenery and content he or she wants, or a space where the user is able to take care of his or her inner self and prepare or finish his or her day, by means of the vehicle.

Thus, the vehicle control apparatus may adjust a mood of the space by means of the setting for controlling the interior environment of the vehicle.

According to an embodiment, the vehicle control apparatus may combine the image, the sound, the arrangement of the at least one seat, the interior temperature, and the window opening and closing degree together as well as the lighting state and may control the interior environment of the vehicle. Thus, the efficiency of mood formation may increase depending on the expanded elements. At this time, elements constituting the interior environment of the vehicle may include other elements capable of affecting the senses of the user as well as the image, the sound, the arrangement of the at least one seat, the interior environment, and the window opening and closing degree.

According to an embodiment, the vehicle control apparatus may vary and store a combination among the elements (e.g., the image, the sound, the arrangement of the at least one seat, the interior environment, and the window opening and closing degree) constituting the interior environment. The user may use the stored setting if necessary. The vehicle control apparatus may provide the user with a setting according to feelings of the user and may create an expanded space.

According to an embodiment, the user may share a setting registered by him or her, such as sharing on a social network service (SNS), with a user different from him or her. Furthermore, the user may check information about a setting shared by an influencer or a different user (e.g., an acquaintance or a registered user) by means of a terminal of the user and may control the vehicle control apparatus to obtain the setting shared by the influencer or the different user.

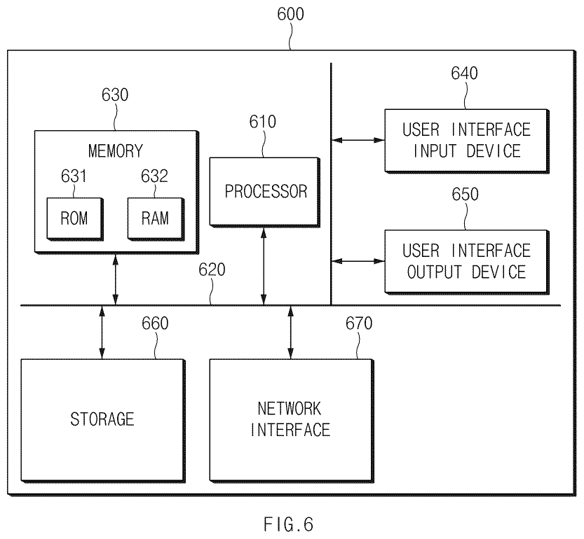

FIG. 6 illustrates a computing system associated with a vehicle control apparatus, a vehicle control method, and a system for providing a vehicle control service according to an embodiment of the disclosure.

Referring to FIG. 6, a computing system 600 may include at least one processor 620, a memory 630, a user interface input device 640, a user interface output device 650, storage 660, and a network interface 670, which are connected with each other via a bus 610.

The processor 610 may be a central processing unit (CPU) or a semiconductor device that processes instructions stored in the memory 630 and/or the storage 660. The memory 630 and the storage 660 may include various types of volatile or non-volatile storage media. For example, the memory 630 may include read-only memory (ROM) 631 and random-access memory (RAM) 632.

Accordingly, the operations of the method or algorithm described in connection with the embodiments disclosed in the specification may be directly implemented with a hardware module, a software module, or a combination of the hardware module and the software module, which is executed by the processor 610. The software module may reside on a storage medium (that is, the memory 630 and/or the storage 660) such as a RAM, a flash memory, a ROM, an EPROM, an EEPROM, a register, a hard disc, a removable disk, and a CD-ROM.

The exemplary storage medium may be coupled to the processor 610. The processor 610 may read out information from the storage medium and may write information in the storage medium. Alternatively, the storage medium may be integrated with the processor 610. The processor and the storage medium may reside in an application specific integrated circuit (ASIC). The ASIC may reside within a user terminal. In another case, the processor and the storage medium may reside in the user terminal as separate components.

The present technology may provide a setting for controlling an interior environment of the vehicle.

Furthermore, the present technology may provide a setting including a combination of elements constituting the interior environment of the vehicle.

Furthermore, the present technology may share the setting for controlling the interior environment of the vehicle.

Furthermore, the present technology may ensure a vehicle space as a personal space and may provide a mood according to activity of the user.

Furthermore, the present technology may customize the setting for controlling the interior environment of the vehicle.

Furthermore, the present technology may control the interior environment of the vehicle by means of the setting for controlling the interior environment of the vehicle, thus providing an expanded user experience.

Furthermore, the present technology may allow a platform to ensure profits by means of transaction brokerage of the setting for controlling the interior environment of the vehicle.

Furthermore, the present technology may allow the platform to ensure big data by means of the transaction brokerage of the setting for controlling the interior environment of the vehicle.

Furthermore, the present technology may ensure a communication ecosystem between vehicles by means of the transaction brokerage of the setting for controlling the interior environment of the vehicle.

According to an aspect of the present disclosure, a vehicle control apparatus may include a memory storing at least one instruction and a processor that executes the at least one instruction.

According to an embodiment, the processor may execute the at least one instruction to obtain a setting specified based on an input of a user of a vehicle among settings for controlling an internal environment of the vehicle, the settings including at least one of an image, a sound, or a lighting state, or any combination thereof, from a server, and control at least one of a display provided in the vehicle to provide the image, a speaker provided in the vehicle to provide the sound, or lighting provided in the vehicle to provide the lighting state, or any combination thereof, based on the obtained setting.

According to an embodiment, the processor may obtain a setting specified based on an input of the user among settings for controlling the internal environment, the settings including at least one of arrangement of at least one seat provided in the vehicle, an internal temperature of the vehicle, or an opening and closing degree of a window provided in the vehicle, or any combination thereof, from the server, and may control at least one of the at least one seat, an air conditioner provided in the vehicle, or the window, or any combination thereof, based on the obtained setting.

According to an embodiment, the processor may obtain a setting specified based on an input of the user among settings for controlling the internal environment, the settings being recommended based on at least one category into which the user is classified, from the server by means of a vehicle communication device provided in the vehicle to perform wireless or wired communication.

According to an embodiment, the processor may obtain a setting specified based on an input of the user via a user interface among settings stored in the vehicle control apparatus to control the internal environment, may control the at least one of the display, the speaker, or the lighting, or the any combination thereof, based on the obtained setting, and may provide the user with information about the obtained setting.

According to an embodiment, the processor may obtain a setting corresponding to driving information stored in the vehicle control apparatus to indicate a driving situation of the vehicle among settings for controlling the internal environment based on the driving information and may control the at least one of the display, the speaker, or the lighting, or the any combination thereof, based on the obtained setting.

According to an embodiment, the processor may obtain a setting specified based on an input of the user, the setting including at least one of an image included in media content, a sound included in the media content, or a lighting state indicating the media content, or any combination thereof, among the settings for controlling the internal environment from the server.

According to an embodiment, the processor may obtain a setting corresponding to context information stored in the vehicle control apparatus to indicate activity performed by the user among settings for controlling the internal environment based on the context information and may control the at least one of the display, the speaker, or the lighting, or the any combination thereof, based on the obtained setting.

According to another aspect of the present disclosure, a system for providing a vehicle control service may include a vehicle control apparatus, a terminal of a user of a vehicle, and a server of a platform. The terminal may transmit a request for allowing the vehicle control apparatus to obtain a setting specified based on an input of the user among settings for controlling an internal environment of the vehicle, the settings including at least one of an image, a sound, or a lighting state, or any combination thereof, to a server. The server may transmit the specified setting to the vehicle control apparatus. The vehicle control apparatus may control at least one of a display provided in the vehicle to provide the image, a speaker provided in the vehicle to provide the sound, or lighting provided in the vehicle to provide the lighting state, or any combination thereof, based on the specified setting.

According to an embodiment, the terminal may transmit the request for allowing the vehicle control apparatus to obtain the specified setting to the server, based on execution of an application for providing the user with the settings for controlling the internal environment.

According to an embodiment, the terminal may pay a price of the specified setting. The server may transfer an amount corresponding to a portion or all of the price to an account of a seller who uploads the specified setting to the server.

According to an embodiment, the server may classify the user into at least one category, based on personal information of the user, and may recommend at least one setting for controlling the internal environment to the user, based on a frequency at which users included in the at least one category and different from the user obtain a setting for controlling an internal environment of another vehicle. The terminal may provide the user with the recommended at least one setting.

According to an embodiment, the terminal may receive information about at least one setting customized by a user different from the user to control the internal environment from the different user and may transmit the request for allowing the vehicle control apparatus to obtain the setting specified by the input of the user to the server, based on the received information. The terminal may share information about at least one setting customized by the user to control the internal environment with the different user and may transmit the at least one setting corresponding to the shared information and customized by the user to control the internal environment to the server.

According to another aspect of the present disclosure, a vehicle control method may include obtaining, by a processor, a setting specified based on an input of a user of a vehicle among settings for controlling an internal environment of the vehicle, the settings including at least one of an image, a sound, or a lighting state, or any combination thereof, from a server, and controlling, by the processor, at least one of a display provided in the vehicle to provide the image, a speaker provided in the vehicle to provide the sound, or lighting provided in the vehicle to provide the lighting state, or any combination thereof, based on the obtained setting.

According to an embodiment, the vehicle control method may further include obtaining, by the processor, a setting specified based on an input of the user among settings for controlling the internal environment, the settings including at least one of arrangement of at least one seat provided in the vehicle, an internal temperature of the vehicle, or an opening and closing degree of a window provided in the vehicle, or any combination thereof, from the server, and controlling, by the processor, at least one of the at least one seat, an air conditioner provided in the vehicle, or the window, or any combination thereof, based on the obtained setting.

According to an embodiment, the obtaining of the setting specified based on the input of the user of the vehicle among the settings for controlling the internal environment of the vehicle, the settings including the at least one of the image, the sound, or the lighting state, or the any combination thereof, from the server by the processor may include obtaining, by the processor, a setting specified based on an input of the user among settings for controlling the internal environment, the settings being recommended based on at least one category into which the user is classified, from the server by means of a vehicle communication device provided in the vehicle to perform wireless or wired communication.

According to an embodiment, the controlling of the at least one of the display provided in the vehicle to provide the image, the speaker provided in the vehicle to provide the sound, or the lighting provided in the vehicle to provide the lighting state, or the any combination thereof, based on the obtained setting by the processor may include obtaining, by the processor, a setting specified based on an input of the user via a user interface among settings stored in a vehicle control apparatus to control the internal environment, controlling, by the processor, the at least one of the display, the speaker, or the lighting, or the any combination thereof, based on the obtained setting, and providing, by the processor, the user with information about the obtained setting.

According to an embodiment, the controlling of the at least one of the display provided in the vehicle to provide the image, the speaker provided in the vehicle to provide the sound, or the lighting provided in the vehicle to provide the lighting state, or the any combination thereof, based on the obtained setting by the processor may include obtaining, by the processor, a setting corresponding to driving information stored in a vehicle control apparatus to indicate a driving situation of the vehicle among settings for controlling the internal environment based on the driving information and controlling, by the processor, the at least one of the display, the speaker, or the lighting, or the any combination thereof, based on the obtained setting.

According to an embodiment, the obtaining of the setting specified based on the input of the user of the vehicle among the settings for controlling the internal environment of the vehicle, the settings including the at least one of the image, the sound, or the lighting state, or the any combination thereof, from the server by the processor may include obtaining, by the processor, a setting specified based on an input of the user, the setting including at least one of an image included in media content, a sound included in the media content, or a lighting state indicating the media content, or any combination thereof, among the settings for controlling the internal environment from the server.

According to an embodiment, the controlling of the at least one of the display provided in the vehicle to provide the image, the speaker provided in the vehicle to provide the sound, or the lighting provided in the vehicle to provide the lighting state, or the any combination thereof, based on the obtained setting by the processor may include obtaining, by the processor, a setting corresponding to context information stored in a vehicle control apparatus to indicate activity performed by the user among settings for controlling the internal environment based on the context information and controlling, by the processor, the at least one of the display, the speaker, or the lighting, or the any combination thereof, based on the obtained setting.

According to an embodiment, the settings for controlling the internal environment of the vehicle, the settings including the at least one of the image, the sound, or the lighting state, or the any combination thereof may include settings shared from a user different from the user and customized by the different user to control the internal environment.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus comprising:
a memory storing at least one instruction; and
a processor configured to execute the at least one instruction to:
obtain, from a server and among a plurality of settings for controlling an interior environment of a vehicle, a setting specified by an input of a user of the vehicle, wherein the plurality of settings comprise at least one of an image, a sound, or a lighting state; and
control, based on the setting, at least one of:
a display of the vehicle to provide the image,
a speaker of the vehicle to provide the sound, or
a light source of the vehicle to provide lighting according to the lighting state.

2. The vehicle control apparatus of claim 1, wherein the setting further comprises at least one of:
a seat position of a seat of the vehicle,
an interior temperature of the vehicle, or
a window position of a window of the vehicle, and
wherein the processor is further configured to execute the at least one instruction to control, based on the setting, at least one of:
the seat according to the seat position,
an air conditioner of the vehicle according to the interior temperature of the vehicle, or
the window according to the window position.

3. The vehicle control apparatus of claim 1, wherein the setting is recommended based on at least one user category of the user, and
wherein the processor is configured to obtain the setting by:
obtaining the setting from the server via a communication device, of the vehicle, configured to perform wireless or wired communication.

4. The vehicle control apparatus of claim 1, wherein the processor is further configured to execute the at least one instruction to:
obtain, via a user interface and among a second plurality of settings for controlling the interior environment, a second setting, wherein the second plurality of settings are stored in the vehicle control apparatus;
control, based on the second setting, at least one of the display, the speaker, or the light source; and
provide the user with information about the second setting.

5. The vehicle control apparatus of claim 1, wherein the processor is further configured to execute the at least one instruction to:
obtain, among a second plurality of settings for controlling the interior environment, a second setting corresponding to driving information associated with the vehicle, wherein the second plurality of settings are stored in the vehicle control apparatus; and
control, based on the second setting, at least one of the display, the speaker, or the light source.

6. The vehicle control apparatus of claim 1, wherein at least one of the image, the sound, or the lighting state is associated with a media content.

7. The vehicle control apparatus of claim 1, wherein the processor is further configured to execute the at least one instruction to:
obtain, among a second plurality of settings for controlling the interior environment, a second setting corresponding to context information indicating an activity performed by the user; and
control, based on the second setting, at least one of the display, the speaker, or the light source.

8. A system for providing a vehicle control service, the system comprising:
a vehicle control apparatus; and
a terminal of a user of a vehicle,
wherein the terminal is configured to:
transmit, to a server, a request to send, to the vehicle control apparatus and among a plurality of settings for controlling an interior environment of the vehicle, a setting specified by an input of the user, wherein the plurality of settings comprise at least one of an image, a sound, or a lighting state, and
wherein the vehicle control apparatus is configured to:
receive, from the server; and
control, based on the setting, at least one of:
a display of the vehicle to provide the image,
a speaker of the vehicle to provide the sound, or
a light source of the vehicle to provide lighting according to the lighting state.

9. The system of claim 8, wherein the terminal is further configured to:
present, to the user via an application executing on the terminal, the plurality of settings.

10. The system of claim 8, wherein the terminal is further configured to:
transmit a request for an authorization for a transaction associated with the setting.

11. The system of claim 8, wherein at least one of the vehicle control apparatus or the server is further configured to:
classify, based on personal information of the user, the user into at least one category; and
generate, for the user and based on a preference of other users in the at least one category, at least one recommended setting for controlling the interior environment, and
wherein the terminal is further configured to:
provide, to the user, the at least one recommended setting.

12. The system of claim 8, wherein the terminal is further configured to:
receive, from a second terminal associated with a second user, first information about at least one setting customized by the second user, wherein the setting specified by the input of the user is based on the first information;
transmit, to the second terminal, second information about at least one setting customized by the user to control the interior environment; and
transmit, to the server, the at least one setting customized by the user to control the interior environment.

13. A vehicle control method comprising:
obtaining, by a processor, from a server, and among a plurality of settings for controlling an interior environment of a vehicle, a setting specified by an input of a user of the vehicle, wherein the plurality of settings comprise at least one of an image, a sound, or a lighting state; and
controlling, by the processor and based on the setting, at least one of:
a display of the vehicle to provide the image,
a speaker of the vehicle to provide the sound, or
a light source of the vehicle to provide lighting according to the lighting state.

14. The vehicle control method of claim 13, wherein the setting further comprises at least one of:
a seat position of a seat of the vehicle,
an interior temperature of the vehicle, or
a window position of a window of the vehicle, and
wherein the vehicle control method further comprises controlling, by the processor and based on the setting, at least one of:
the seat according to the seat position,
an air conditioner of the vehicle according to the interior temperature of the vehicle, or
the window according to the window position.

15. The vehicle control method of claim 13, wherein the setting is recommended based on at least one user category of the user, and
wherein the obtaining of the setting comprises obtaining the setting from the server via a communication device, of the vehicle, configured to perform wireless or wired communication.

16. The vehicle control method of claim 13, further comprising:
obtaining, by the processor, via a user interface, and among a second plurality of settings for controlling the interior environment, a second setting, wherein the second plurality of settings are stored in a vehicle control apparatus;
controlling, by the processor and based on the second setting, at least one of the display, the speaker, or the light source; and
providing, by the processor, the user with information about the second setting.

17. The vehicle control method of claim 13, further comprising:
obtaining, by the processor and among a second plurality of settings for controlling the interior environment, a second setting corresponding to driving information associated with the vehicle, wherein the second plurality of settings are stored in a vehicle control apparatus; and
controlling, by the processor and based on the second setting, at least one of the display, the speaker, or the light source.

18. The vehicle control method of claim 13, wherein at least one of the image, the sound, or the lighting state is associated with a media content.

19. The vehicle control method of claim 13, further comprising:
obtaining, by the processor and among a second plurality of settings for controlling the interior environment, a second setting corresponding to context information indicating an activity performed by the user; and
controlling, by the processor and based on the second setting, at least one of the display, the speaker, or the lighting, or the light source.

20. The vehicle control method of claim 13, wherein the settings further comprise:
one or more settings shared by a second user and customized by the second user.
